(19) United States
(12) Patent Application Publication
(10) Pub. No.: US 2008/0040705 A1
(43) Pub. Date: Feb. 14, 2008

(54) METHOD FOR BUILDING SOFTWARE PROJECT

(75) Inventor: Soon-Yong JEONG, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/835,510

(22) Filed: Aug. 8, 2007

(30) Foreign Application Priority Data
Aug. 8, 2006 (KR) 2006-74914

(51) Int. Cl. G06F 9/44

(52) U.S. Cl. 717/122

(57) ABSTRACT

A method for building a software project, the method including the steps of receiving a makefile for building one software project, generating an object list of the received makefile, selecting one build target from the generated object list according to a preset order, sequentially compiling the child modules included in the build target when the selected build target includes child modules, updating a library file of an ancestor module having an inheritance relation with each of the compiled child modules, determining if all the build targets in the object list have been compiled; and generating a new execution file by using results obtained by compiling all the build targets when all the build targets have been compiled.

### PRIORITY

This application claims priority under 35 U.S.C. §119 to an application entitled “Method For Building Software Project” filed in the Korean Intellectual Property Office on Aug. 8, 2006 and assigned Serial No. 2006-74914, the contents of which are incorporated herein by reference.

### BACKGROUND OF THE INVENTION

1. Field of the Invention

The present invention relates to software, and more particularly to a method for building a software project.

2. Description of the Related Art

A “build” is to compile and link a source file so as to generate a final execution file.

A build uses a make utility, and various make tools including make, nmake, gunmake, etc., exist. These commonly have an input file storing information related to a build called a makefile. The makefile is analyzed according to grammar determined for each make utility, so that a build is performed.

Hereinafter, an example of a makefile for building a software project by executing a conventional make utility in this way will be described with reference to FIGS. 1A to 1C.

FIG. 1A partially illustrates a part defining environment variables used by a makefile. Referring to FIG. 1A, all variables are basically set as global variables for operation as defined in the reference number 100 of FIG. 1A. Therefore, since variables are globally declared when building a project, it is difficult to perform a modularized build.

FIG. 1B illustrates an example of a part defining compile rules in a makefile. That is, FIG. 1B partially illustrates compile rules of a file c. According to the prior art, as illustrated in FIG. 1B, since it is difficult to define rules, which build an object file by compiling the file c, by the module, compile rules are very complicated and hard to read in a makefile. FIG. 1C illustrates an example defining a source in which a make object file must be partially compiled into VPATH information and an object file list, instead of a source file list, when building a software project according to the prior art. Hereinafter, a case of generating a file A by executing a make will be described with reference to FIGS. 1A-C. A user defines a makefile in order to stipulate rules, variables and source files for generating the file A. Assuming that these variables are A.o, A.h and A.c, when a make is executed in order to generate the file A, the variables and sources are globally declared, and a program executing the make individually searches for the variables and source files for generating the file A from each directory defined in a VPATH. Therefore, when building a software project according to the prior art, it takes too much time to read variables, and the probability of an error is high if a path is not properly designated.

Recently, the portion of software has increased in an embedded system such as a mobile communication terminal as well as a Personal Computer (PC) system, and thus the size of a source file constituting the software has also increased. In the case of a mobile communication terminal, the size of an entire source file may be as large as several hundred MB (mega bytes), and the number of files may be as high as several tens of thousands MB.

Hence, when building such a large scale software project, it is more difficult to perform a modularized build because variables or targets are basically and globally declared for operation. Further, the values of variables do not sequentially change and many reserved special signs and implicit rules exist. Therefore, when an existing global declaration is used, the readability of a make utility for the makefile is greatly reduced as the makefile becomes more complicated. In addition, both the processing of implicit rules and processes, which must be performed in order to find dependent files from a file system, increase. Therefore, a build speed become slower.

### SUMMARY OF THE INVENTION

Accordingly, the present invention has been made to solve the above-mentioned problems occurring in the prior art, and an object of the present invention is to provide a method for elevating a build speed by increasing the readability of variables and source files when building a software project, and reducing the probability of an error in the read process of the variables and source files.

In accordance with one aspect of the present invention, there is provided a method for building a software project, the method including: receiving a makefile for building one software project; generating an object list of the received makefile; selecting one build target from the generated object list according to a preset order; sequentially compiling the child modules included in the build target when the selected build target includes child modules;, updating a library file of an ancestor module having an inheritance relation with each of the compiled child modules; determining if all the build targets in the object list have been compiled; and generating a new execution file by using results obtained by compiling all the build targets, when it is determined that all the build targets have been compiled.

### BRIEF DESCRIPTION OF THE DRAWINGS

The above and other objects, features and advantages of the present invention will be more apparent from the following detailed description taken in conjunction with the accompanying drawings, in which:

FIGS. 1A to 1C are files illustrating a conventional makefile used when building a software project; FIGS. 2A and 2B are exemplary views of a project definition for generating a software project when building a software project according to the present invention;

FIG. 3 is a flow diagram illustrating an operation for building a software project according to the present invention; and

FIGS. 4A and 4B are diagrams illustrating the module of a software project generated according to the present invention.

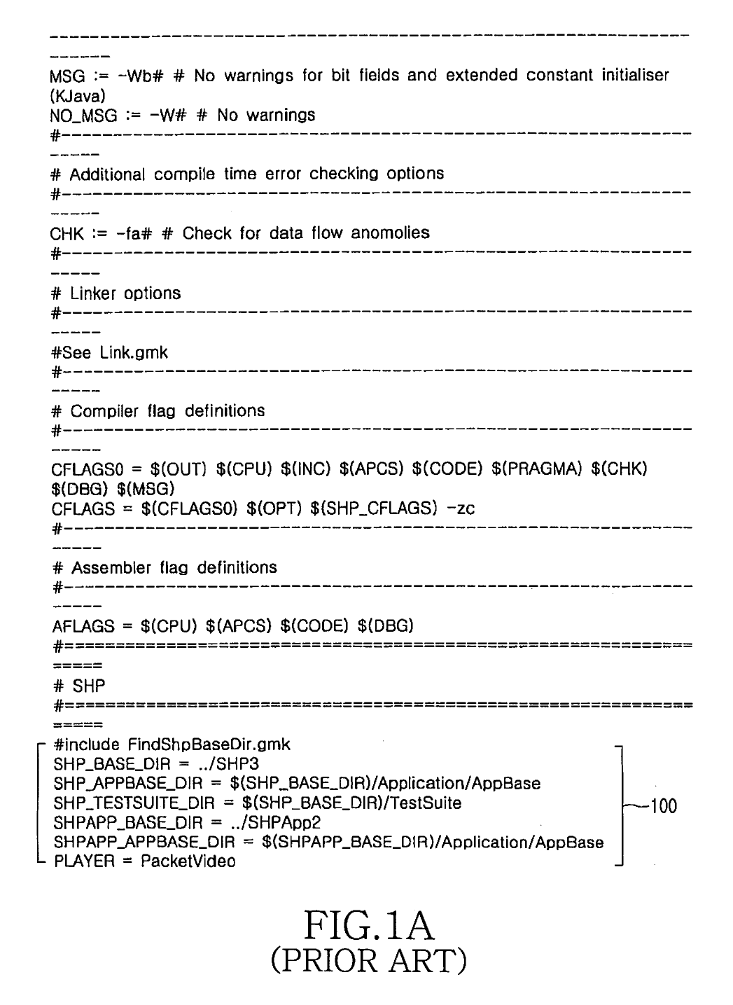

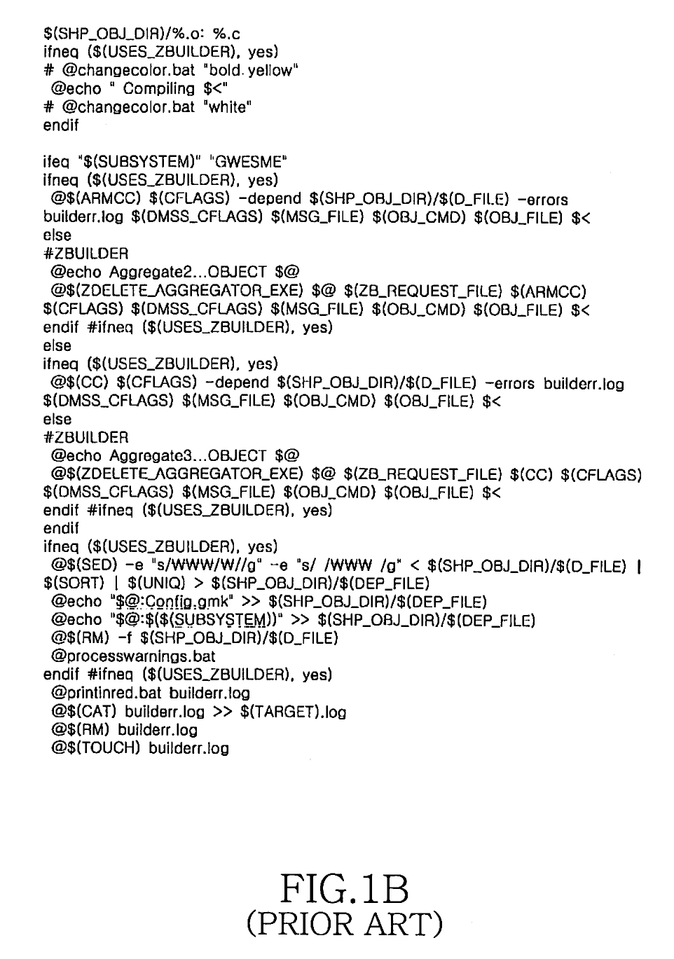

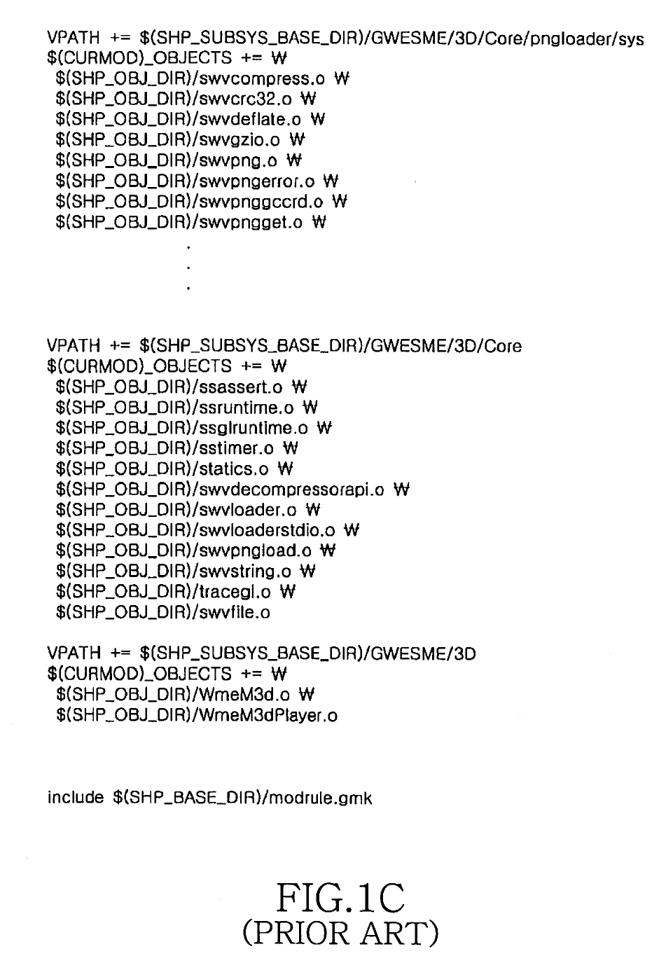

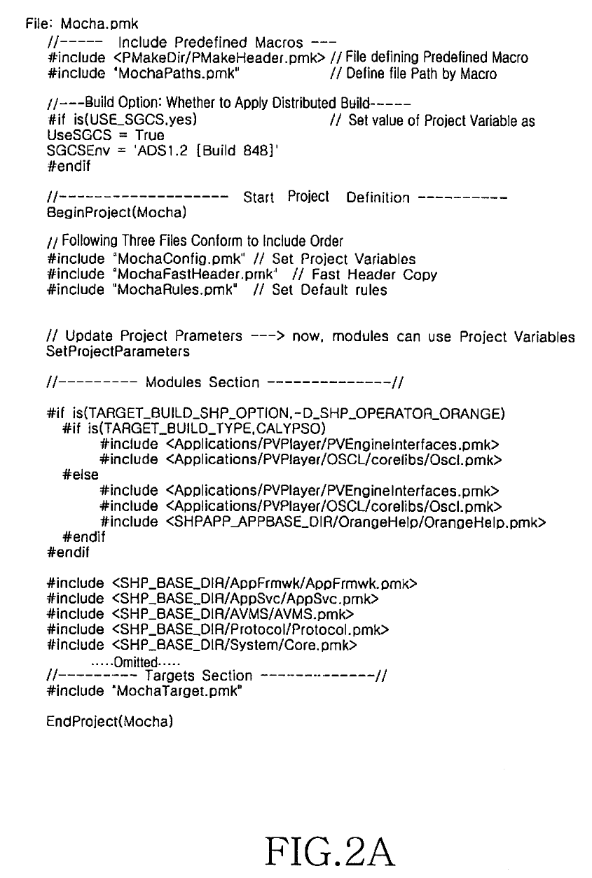

### DETAILED DESCRIPTION OF THE PREFERRED EMBODIMENT

A preferred embodiment of the present invention will be described in detail herein below with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present invention.

The present invention defines one project by using one or more modules, targets and variables in a makefile, and objectifies and defines the one or more modules, targets and variables, in order to provide a method for efficiently building a software project. Further, the objectified targets and modules are respectively compiled by declaring defined source files and variables, so that it is possible to increase the readability of the source files and variables required according to the modules and to decrease the probability of an error which may occur when the variables and source files are read.

Hereinafter, a method for building a software project according to the present invention will be described.

FIGS. 2A and 2B are files illustrating a project definition for generating a software project when building the software project according to the present invention.

First, it is assumed that the name of a software project build system according to the present invention is defined as PyMake, and the makefile of the PyMake uses a Python program used in an existing script language. Further, a Mocha project used as the software of a mobile communication terminal will be described as an example of a project.

FIG. 2A illustrates an example of a definition of source files and variables necessary for performing the Mocha project.

Referring to FIG. 2A, the recitation “#include<PMakeDir/PMakeHeader.pmk>” in the first line includes the basic predefined macro of the PMake and a setup for enabling a PyMake program to be used. Herein, global setup is to define macros or variables to be used throughout the build, and the file “Mocha.pmk” defines various file paths in this part.

Further, the macro “BeginProject” is a part declaring a project object. The project-related setup part, i.e., “Start Project Definition,” is a part defining the setup of various elements to be used in the project. The “Modules Section” is a module definition list, and the module definition list is of arranging modules to be included in the project. This part (i.e., the “Modules Section”) starts with the “BeginModule” or “BeginChildModule” and ends with “EndModule” or “EndChildModule.” The module definition part is divided into a separate file and is included in the source file by using a command #include. In this way, it can be easier to add or delete a module. The macro “EndProject” calls the Run function of a project object, as shown at the bottom of FIG. 2A.

FIG. 2B illustrates an example of a definition of both variables for performing the Mocha project and compile rules. The software project build system according to the present invention compiles modules and targets according to the compile rules illustrated in FIG. 2B.

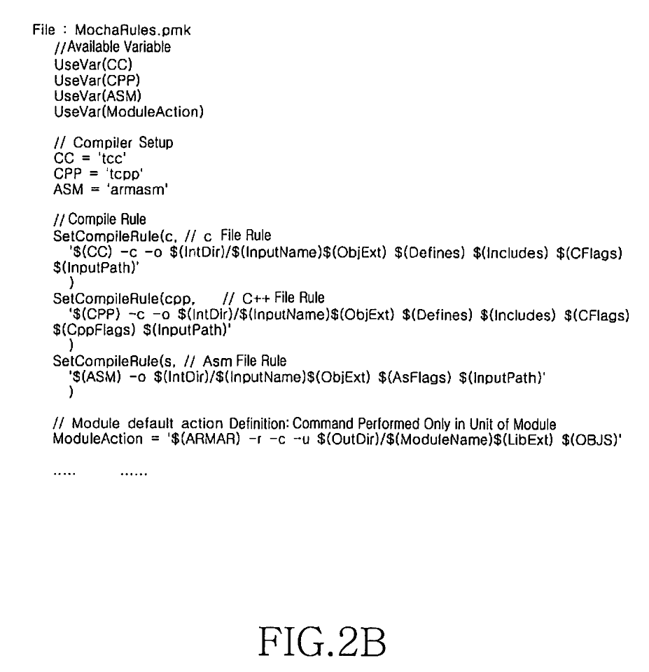

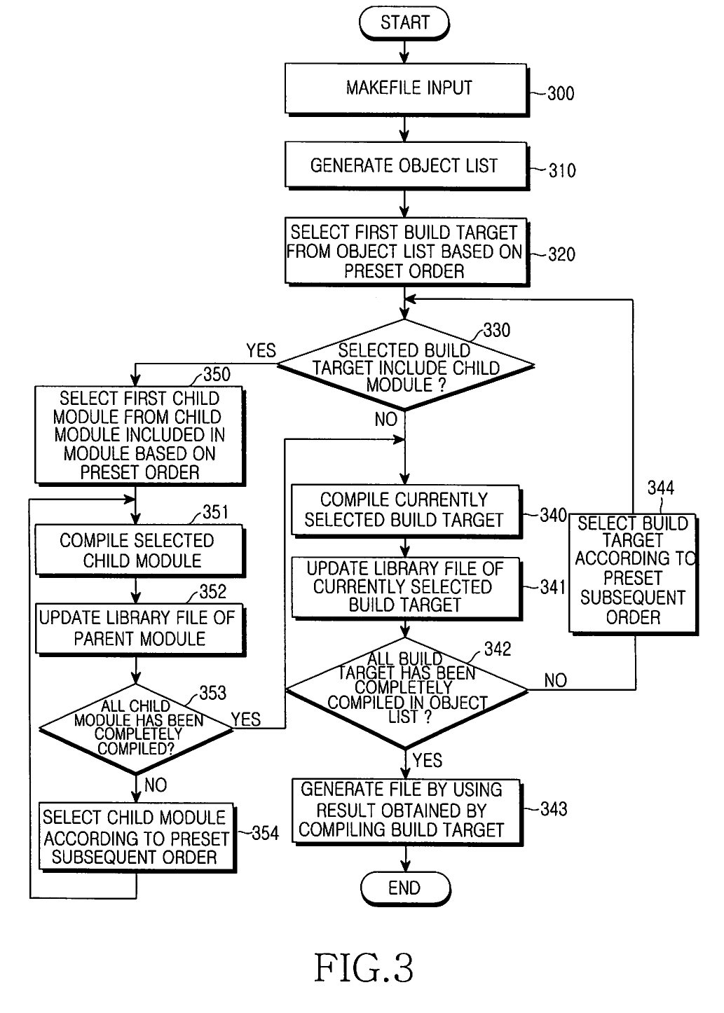

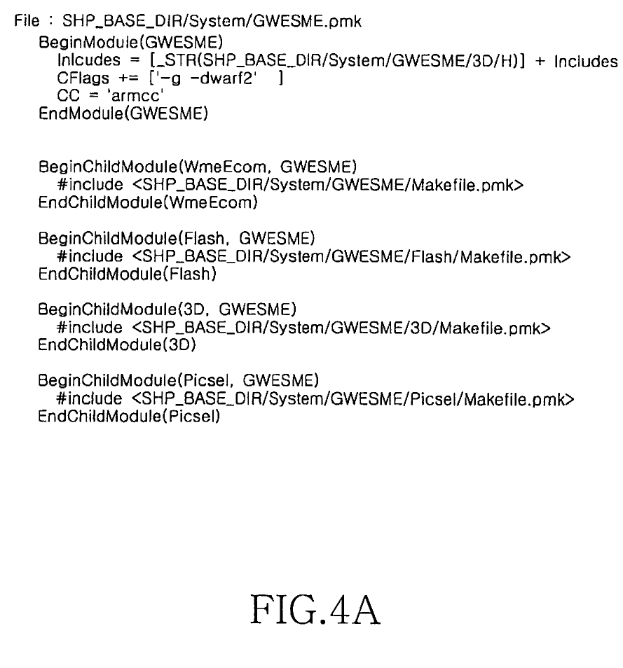

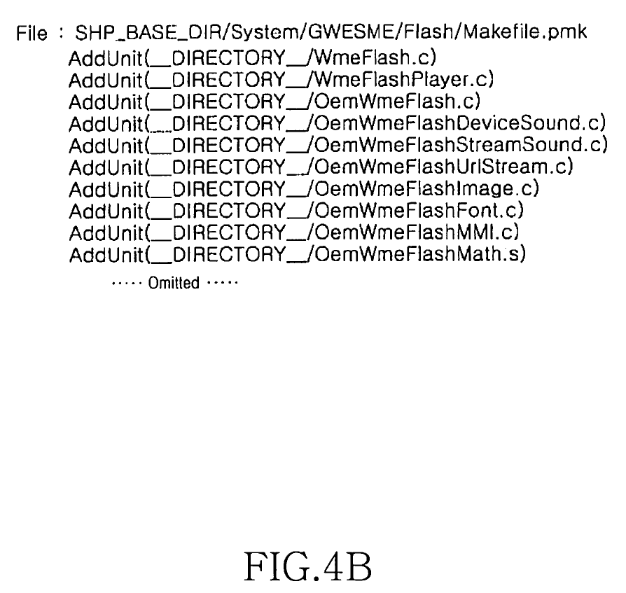

Hereinafter, the method for building the software project according to the present invention will be described with reference to FIGS. 3 and 4A-4B.

FIG. 3 is a flow chart illustrating an operation for building the software project according to the present invention, and FIGS. 4A and 4B are diagrams illustrating an example of the module of the software project generated according to the present invention.

Referring to FIGS. 3 and 4A and 4B, if a user creates a makefile according to the preset PMK (Python-based MaKe tool). grammar, the software project build system according to the present invention receives the makefile defined by the user in step 300. The makefile defines one or more modules, targets and variables, and rules when building the software project, and defines a predefined function for efficiently compiling various versions of projects. PMK is a makefile created on the basis of Python objecting a project build system.

FIG. 4A illustrates the modules, targets and variables defined by the user as described above. The definition of the project starts from the macro “BeginProject” and ends with the macro “EndProject”. The macro “BeginProject” is a part declaring a project object. In the project, a module is defined between the “BeginModule” and the “EndModule” within the macro “EndProject” and the macro “BeginProject”. A child module inheriting the variable of the module is defined between the BeginChildModule and the EndChildModule, and as the above described, the target may be defined between the BeginTarget and the EndTarget. The project object defines the default value of a variable to be used in internal module and target.

If the makefile is input in step 300, the software project build system according to the present invention generates an object list input to the makefile in step 310. The object list includes respective project variables for a project to be executed, respective modules, and module internal variables and compile units included in each module. Herein, a module and a child module are distinguished according to a variable inheritance relation among the respective modules. The module and the child module include a compile unit and a module variable, respectively, and have an independent name space by the compile unit and the module variable, respectively. Further, each module and the child module of said each module are distinguished according to whether the name of another module is included in the name space. In the variable, a compile flag, compile rules based on extensions, module archive generation rules, etc., are basically declared. If required, a user variable may be added. The module includes a compile unit and a variable.

Herein, the software project build system according to the present invention directly and clearly defines a source file by using the compile unit of the module, thereby saving time required to search for many directories and find a source file in order to generate an object, as compared to a method which clearly defines the name of an existing object. The internal variable of the module is basically shifted from the variable of the project, which may also be shifted from other modules. The range of the module internal variable belongs to the module itself and a child module transferring the variable of the module. Accordingly, an inheritance relation is formed between the module the child module. If the module is compiled, the child module is automatically compiled. If the child module is compiled, the archive file of an ancestor module, i.e., the module transferring the internal variable to the child module, is updated. The module and the child module inheriting the variable of the module as described above may be created by a makefile as illustrated in FIG. 4B. The module illustrated in FIG. 4B is a child module forming an inheritance relation with a module “GWESME”, and denotes a compile unit included in a flash module that is a child module of the module “GWESME”. The compile unit included in the module includes the position of the source file of the module and sets a compile unit, thereby reducing the possibility of generating an error when globally setting a source file through the VPATH according to the prior art, and shortening time required to find a corresponding source file from the globally set source file.

Further, a target is defined by variables. The value of the variable is inherited from the project and can be redefined in the internal of the target object. Important variables in a target are defined by a target, which must be preferentially executed in order to execute the target, a dependence list variable collecting the names of modules which must be complied, and a command variable for executing the target.

When receiving the makefile and generating the object list, the software project build system according to the present invention also recognizes an inheritance relation for each project. That is, if the object list is generated in step 310, the software project build system according to the present invention selects the first target from the object list based on a preset order in step 320. Herein, a build target is a basic operation factor of a software project, which includes a target, a module and a child module. The build target is classified as an objectified target and a module according to whether the build target includes a compile unit. In other words, a build target including the compile unit is defined as a module, and a build target not including the compile unit is defined as an objectified target. The module has a default operation. If there exists a build target having formed an inheritance relation after inheriting the variable of the module, this build target is defined as a child module.

If the first target is selected in step 320, the software project build system according to the present invention determines if the selected target includes child modules in step 330. If the selected target includes the child modules, the software project build system according to the embodiment of the present invention selects the first child module from the child modules included in the module based on a preset order in step 350. After selecting the first child module, the software project build system according to the present invention sequentially compiles the selected child module in step 351. Herein, the compile operation is equal to that in a general program. That is, if an object exists in the compile operation, the software project build system determines if there exist a source and rules corresponding to the object. If the preset rules exist, the software project build system generates the object by using the source according to the rules. If there is no object, the software project build system performs recompiling and determines if a source has changed. Then, the software project build system determines if an update is necessary. If the update is necessary, the software project build system updates the source file and completes the compiling. Further, when compile rules have not been preset by a user, the compiling is processed by the extension rules of a compile unit. The extension rules are to determine compile rules to be applied according to the extensions of the source file. Since a more detailed compiling process is equal to an existing compiling process, details will be omitted.

After compiling the selected child module in step 351, the software project build system according to the present invention sequentially updates the library file of a parent module in step 352, and determines if all the child modules have been completely compiled in step 353. If it is determined that all the child modules have not been completely compiled, the software project build system according to the present invention selects a child module according to a preset subsequent order in step 354, and then returns to step 351.

However, if it is determined that all the child modules have been completely compiled in step 353, the software project build system according to the present invention compiles the currently selected build target in step 340, and updates the library file of the currently selected build target in step 341. If the update of the library file of the build target is completed, the software project build system according to the present invention determines if all the build targets have been completely compiled in the object list in step 342. If it is determined that an uncompiled build target exists in the object list, the software project build system according to the present invention selects a build target according to a preset subsequent order in step 344, and then returns to step 330. However, if it is determined that all the build targets have been completely compiled in the object list in step 342, the software project build system according to the present invention performs an operation defined in each build target by using results obtained by compiling the build targets, thereby generating a file in step 343. Returning to step 330, if it is determined that the selected build target is a target, i.e., an objectified target, not including both the child modules and the compile unit, step 340 is performed. Further, when an operation as defined in the module does not exist in the objectified target, an executable default operation has not been determined.

In this way, according to the present invention, since targets and variables are not globally declared when building the software project, it is easy to perform a modularized build. Further, since it is not necessary to perform the processing of implicit rules and processes, which must be performed in order to find dependent files such as dependent modules or dependent targets from a file system, a build speed is enhanced.

According to the present invention, a method for building a software project can quickly build a large scale software project including a plurality of modules by objectifying one or more modules, targets and variables included in the project. In addition, a plurality of objectified modules are sequentially compiled, so that efficient maintenance and debugging is possible.

Although a preferred embodiment of the present invention has been described for illustrative purposes, those skilled in the art will appreciate that various modifications, additions and substitutions are possible, without departing from the scope and spirit of the present invention as disclosed in the accompanying claims, including the full scope of equivalents thereof. For example, when building various software projects, the present invention can be variously modified depending on the configurations of the projects. Further, it goes without saying that a software project build system can be applied to a computer system.

What is claimed is:

1. A method for building a software project, the method comprising the steps of:
receiving a makefile for building a software project;
generating an object list of the received makefile;
selecting a build target from the generated object list according to a preset order;
sequentially compiling child modules included in the build target, when the selected build target includes child modules;.
updating a library file of an ancestor module having an inheritance relation with each of the compiled child modules;
determining when all the build targets in the object list have been compiled; and
generating a new execution file by using results obtained by compiling all the build targets, when all the build targets have been compiled.

2. The method as claimed in claim 1, wherein the step of generating the object list comprises:
objectifying at least one module, target and variable, which are included in one project, into respective build targets for generation;
defining a build target, which includes a compile unit among the build targets, as a module;
defining a build target, which includes a compile unit and inherits a variable from another module among the build targets, as a child module; and
defining a build target among the build targets as an objectified module, the build target not having a compile unit or a child module having an inheritance relation with an ancestor module.

3. The method as claimed in claim 2, wherein the module defining the build target has an independent name space by the compile unit and a module variable, and has an independent name space by the compile unit and the module variable.

4. The method as claimed in claim 3, wherein the module variable inherits a variable of a project and a variable from another module, and the module variable has a range from the module variable itself to a module variable of a module inheriting the module variable itself.

5. The method as claimed in claim 2, wherein the variable objectified into the build target declares compile rules based on a compile flag and an extension, and module archive generation rules, and has a user variable corresponding to a user.

6. The method as claimed in claim 2, wherein the objectified target is defined by variables, the variable inherits its own value from a project, and the value is redefined within the target object.

7. The method as claimed in claim 1, further comprising directly compiling a currently selected target, when the selected build target does not include the child modules.

8. The method as claimed in claim 1, further comprising performing a default operation, when there is no defined operation.
